(19) United States
(12) Patent Application Publication
(10) Pub. No.: US 2025/0015391 A1
(43) Pub. Date: Jan. 9, 2025

(54) BATTERY PACK AND MANUFACTURING METHOD THEREOF

(71) Applicant: Honda Motor Co., Ltd., Tokyo (JP)

(72) Inventors: Fumio SATO, Tokyo (JP); Hiroki MAEMOTO, Tokyo (JP); Masashi MACHIDA, Tokyo (JP); Koichiro KINUGAWA, Tokyo (JP)

(73) Assignee: Honda Motor Co., Ltd., Tokyo (JP)

(21) Appl. No.: 18/757,520

(22) Filed: Jun. 28, 2024

(30) Foreign Application Priority Data
Jul. 4, 2023 (JP) 2023-110355

(51) Int. Cl. H01M 10/6568; H01M 10/613; H01M 10/6554; H01M 50/209

(52) U.S. Cl. CPC H01M 10/6568; H01M 10/613; H01M 10/6554; H01M 50/209

(57) ABSTRACT

A battery pack includes a battery case, battery cells, and coolant jackets. The coolant jacket includes two thin plates having plasticity that are surface-joined to each other, and a coolant inlet, a coolant passage, and a coolant outlet that are formed as gap portions. The battery cell and the coolant jacket are alternately arranged in surface contact with each other in the battery case. By flowing a non-compressed fluid at a predetermined pressure into the coolant passage of the coolant jacket to expand the coolant jacket by plastic deformation, the battery cells and the coolant jackets are clamped and fixed between two end plates.

### CROSS-REFERENCE TO RELATED APPLICATION

This application claims the priority benefit of Japan application serial no. 2023-110355, filed on Jul. 4, 2023. The entirety of the above-mentioned patent application is hereby incorporated by reference herein and made a part of this specification.

### BACKGROUND

### Technical Field

The disclosure relates to a battery pack for a battery electric vehicle (BEV) and a manufacturing method thereof.

### Related Art

Battery cells used in battery packs for a battery electric vehicle (BEV) require mounting under a pressure applied at a load. Thus, currently, in most battery packs, a battery module is configured by bundling a plurality of cells tightly together, and a plurality of such modules are mounted (e.g., see Patent Document 1 (Japanese Patent Application Laid-Open No. 2013-16467)). Further, temperature management is necessary for exerting performance of the battery cells. Currently, to deal with heat generation during charging and discharging, water jackets for cooling (and heating depending on the requirement) are laid out under a module mounting part, and temperature management is performed from bottom surfaces of the battery cells.

In such a battery pack in a module-to-pack (MTP) form, there is a limit to a quantity of mounted battery cells due to the space used by the structure body of each battery module. With the demands for expanding a battery capacity and increasing a voltage, to deal with an increase in the quantity of mounted battery cells, a cell-to-pack (CTP) form, which directly mounts battery cells into a battery pack, is also being considered (e.g., see Patent Document 2 (Japanese Patent Application Laid-Open No. 2023-502274) and Patent Document 3 (Japanese Patent Application Laid-Open No. 2023-509695)).

However, in the above cell-to-pack form, it is a challenge to both arrange individual battery cells in a pack and apply a pressure to the battery cells to mount the battery cells. Further, in the case of dealing with rapid charging, temperature management of the battery becomes more important, but there are limits with bottom surface cooling, and cooling of cell side surfaces is required.

### SUMMARY

According to an embodiment, the disclosure is a battery pack (1) including a battery case (10) in a substantially box shape; a plurality of battery cells (20) accommodated in the battery case; and a plurality of coolant jackets (30) cooling the plurality of battery cells. Each of the coolant jackets (30) includes two thin plates (31 and 32) having plasticity that are surface-joined to each other, and a coolant inlet (33), a coolant passage (34), and a coolant outlet (35) that are formed as gap portions between the two thin plates. The battery cell (20) and the coolant jacket (30) are alternately in surface contact with each other and arranged in a first direction (A-A) in the battery case (10). By flowing a non-compressed fluid at a predetermined pressure into the coolant passage (34) of each of the coolant jackets (30) to expand the coolant jacket (30) by plastic deformation, the plurality of battery cells (20) and the plurality of coolant jackets (30) are clamped and fixed between two end plates (11 and 12) opposed in the first direction.

According to another embodiment, a manufacturing method of a battery pack (1) of the disclosure is a method of manufacturing a battery pack (1) including: a battery case (10) in a substantially box shape; a plurality of battery cells (20) accommodated in the battery case (10); and a plurality of coolant jackets (30) cooling the plurality of battery cells (20). Each of the coolant jackets (30) includes two thin plates (31 and 32) having plasticity that are surface-joined to each other, and a coolant inlet (33), a coolant passage (34), and a coolant outlet (35) formed as gap portions between the two thin plates (31 and 32). The manufacturing method includes steps below. In the battery case (10), the battery cell (20) and the coolant jacket (30) are brought into surface contact alternately with each other in the battery case (10) to arrange in a first direction (A-A). A non-compressed fluid at a predetermined pressure is flowed into the coolant passage (34) of each of the coolant jackets (30) to expand the coolant jacket (30) by plastic deformation, thereby clamping and fixing the plurality of battery cells (20) and the plurality of coolant jackets (30) between two end plates (11 and 12) opposed in the first direction.

The reference signs in brackets above indicate reference signs of components corresponding to embodiments to be described later as examples of the disclosure.

### BRIEF DESCRIPTION OF DRAWINGS

FIG. 1 is a plan view schematically showing a battery pack according to a first embodiment of the disclosure.

FIG. 2 is an enlarged view of a part C of the battery pack in FIG. 1.

FIG. 3A and FIG. 3B are views showing a cell joined body. FIG. 3A is a plan view and FIG. 3B is a front view.

FIG. 4A and FIG. 4B are views showing a coolant jacket. FIG. 4A is a plan view and FIG. 4B is a front view.

FIG. 5A and FIG. 5B are schematic views showing a D-D cross-section of the coolant jacket in FIG. 4B. FIG. 5A shows a state before expansion and FIG. 5B shows a state after expansion.

FIG. 6A to FIG. 6D are plan views showing a manufacturing method of the battery pack in FIG. 1. FIG. 6A shows a battery cell group before joining. FIG. 6B shows a joined body after the cells are joined. FIG. 6C shows an adhered body of a cell joined body and a coolant jacket before expansion. FIG. 6D shows a state in which flexible hoses are further attached.

FIG. 7 is a plan view showing a manufacturing method of the battery pack in FIG. 1, showing a state in which the adhered bodies of the cell joined bodies and the coolant jackets before expansion are arranged in the battery case.

FIG. 8 is a plan view showing a battery pack according to a second embodiment of the disclosure.

FIG. 9 is an enlarged view of a part E of the battery pack in FIG. 8.

### DESCRIPTION OF EMBODIMENTS

Embodiments of the disclosure provide a battery pack capable of increasing a mounting density of battery cells and capable of cooling each battery cell and tightly pressing and fixing each battery cell.

According to an embodiment, the disclosure is a battery pack (1) including a battery case (10) in a substantially box shape; a plurality of battery cells (20) accommodated in the battery case; and a plurality of coolant jackets (30) cooling the plurality of battery cells. Each of the coolant jackets (30) includes two thin plates (31 and 32) having plasticity that are surface-joined to each other, and a coolant inlet (33), a coolant passage (34), and a coolant outlet (35) that are formed as gap portions between the two thin plates. The battery cell (20) and the coolant jacket (30) are alternately in surface contact with each other and arranged in a first direction (A-A) in the battery case (10). By flowing a non-compressed fluid at a predetermined pressure into the coolant passage (34) of each of the coolant jackets (30) to expand the coolant jacket (30) by plastic deformation, the plurality of battery cells (20) and the plurality of coolant jackets (30) are clamped and fixed between two end plates (11 and 12) opposed in the first direction.

With this configuration, after arranging the battery cells and the coolant jackets before expansion alternately with gaps being present with respect to the two opposing end plates, by expanding the coolant jackets, the battery cells can be fixed in a state in which a pressure is applied to the battery cells.

Further, since the coolant jacket expands due to plastic deformation, even if a hydraulic pressure is set to zero, the deformation state is maintained, and the pressure on the battery cell is also maintained. Thus, another pressing mechanism is not required and the structure can be simplified.

The two end plates (11 and 12) may be end plates constituting both end parts of a battery cell accommodating part (17) in the battery case (10).

In this configuration, that is, applying the disclosure to a battery pack in a cell-to-pack form in which battery cells are directly accommodated in a battery case without modularizing the battery cells, the following effects are achieved in addition to the above effects. That is, when mounting the battery cells in a case, a gap is present with respect to an inner wall of the battery case before the coolant jackets expand. Thus, for example, various mounting methods may be selected, such as mounting each row or the entirety in one set by robot hand gripping, mounting from above using a loader, etc.

Further, since the coolant jackets expand to fill the space defined by the battery cells and the inner wall of the battery case, it is also possible to absorb dimensional variations of manufacturing of the battery case and the battery cells.

Furthermore, by flowing a coolant (such as a cooling water) into the coolant flow path between the two thin plates constituting the coolant jacket after expansion, it becomes possible to cool the cell side surfaces, and it becomes possible to deal with rapid charging with significant heat generation.

Further, despite being hollow and lightweight, the coolant jacket has rigidity and thus also contributes to improving the overall rigidity of the battery pack.

The battery cells (20) may constitute cell joined bodies (20A) each with multiple battery cells arranged and joined in a row in a second direction (B-B) orthogonal to the first direction (A-A). The cell joined body (20A) and the coolant jacket (30) may be alternately arranged in surface contact with each other in the first direction (A-A) in the battery case (10).

With this configuration, since the battery cells can be arranged two-dimensionally in the battery pack, a high-density arrangement becomes possible.

The coolant jacket (30) may include a one end part (30a) protruding from a one end side of the cell joined body (20A) in the second direction (B-B), and an other end part (30b) protruding from an other end side of the cell joined body (20A). The coolant inlet (33) may include a one surface side inlet pipe (33a) protruding in the first direction (A-A) from a one surface side of the one end part (30a), and an other surface side inlet pipe (33b) protruding in the first direction (A-A) from an other surface side of the one end part (30a). The coolant outlet (35) may include a one surface side outlet pipe (35a) protruding in the first direction (A-A) from the one surface side of the other end part (30b), and an other surface side outlet pipe (35b) protruding in the first direction (A-A) from the other surface side of the other end part (30b). Upon bringing two of the coolant jackets (30) adjacent to each other with the cell joined body (20A) interposed therebetween, the one surface side inlet pipe (33a) of one of the coolant jackets (30) may be connected to the other surface side inlet pipe (33b) of the other of the coolant jackets (30). The one surface side outlet pipe (35a) of the one of the coolant jackets (30) may be connected to the other surface side outlet pipe (35b) of the other of the coolant jackets (30).

A connection between the one surface side inlet pipe (33a) and the other surface side inlet pipe (33b) and a connection between the one surface side outlet pipe (35a) and the other surface side outlet pipe (35b) may be each performed via a flexible hose (36).

With these configurations, the coolant inlets and the coolant outlets of the plurality of coolant jackets can be easily connected to each other, respectively. Upon sealing the coolant inlet and the coolant outlet, which are not connected, of a terminal-end coolant jacket, a coolant can be injected from the coolant inlet of a base-end coolant jacket to flow coolant into all the coolant jackets.

The predetermined pressure may be 10 times or more a pressure of a coolant of normal use, and the predetermined pressure may be 3±0.5 MPa.

With this configuration, the coolant jackets can be appropriately expanded, and the battery cells can be fixed in a state in which a pressure is applied to the battery cells.

The battery cell (20) or the cell joined body (20A) may be fixed to an adjacent coolant jacket (30) by adhesion.

With this configuration, misalignment of the battery cells can be prevented when expanding the coolant jackets.

According to another embodiment, a manufacturing method of a battery pack (1) of the disclosure is a method of manufacturing a battery pack (1) including: a battery case (10) in a substantially box shape; a plurality of battery cells (20) accommodated in the battery case (10); and a plurality of coolant jackets (30) cooling the plurality of battery cells (20). Each of the coolant jackets (30) includes two thin plates (31 and 32) having plasticity that are surface-joined to each other, and a coolant inlet (33), a coolant passage (34), and a coolant outlet (35) formed as gap portions between the two thin plates (31 and 32). The manufacturing method includes steps below. In the battery case (10), the battery cell (20) and the coolant jacket (30) are brought into surface contact alternately with each other in the battery case (10) to arrange in a first direction (A-A). A non-compressed fluid at a predetermined pressure is flowed into the coolant passage (34) of each of the coolant jackets (30) to expand the coolant jacket (30) by plastic deformation, thereby clamping and fixing the plurality of battery cells (20) and the plurality of coolant jackets (30) between two end plates (11 and 12) opposed in the first direction.

With this configuration, after arranging the battery cells and the coolant jackets before expansion alternately with gaps being present with respect to the two opposing end plates, by expanding the coolant jackets, the battery cells can be fixed in a state in which a pressure is applied to the battery cells.

The reference signs in brackets above indicate reference signs of components corresponding to embodiments to be described later as examples of the disclosure.

According to the battery pack and the manufacturing method thereof of the disclosure, after arranging the battery cells and the coolant jackets before expansion alternately with gaps being present with respect to the two opposing end plates, by expanding the coolant jackets, the battery cells can be fixed in a state in which a pressure is applied to the battery cells.

Further, since the coolant jacket expands due to plastic deformation, even if a hydraulic pressure is set to zero, the deformation state is maintained, and the pressure on the battery cell is also maintained. Thus, another pressing mechanism is not required and the structure can be simplified.

Hereinafter, embodiments of the disclosure will be described in detail with reference to the accompanying drawings.

### First Embodiment

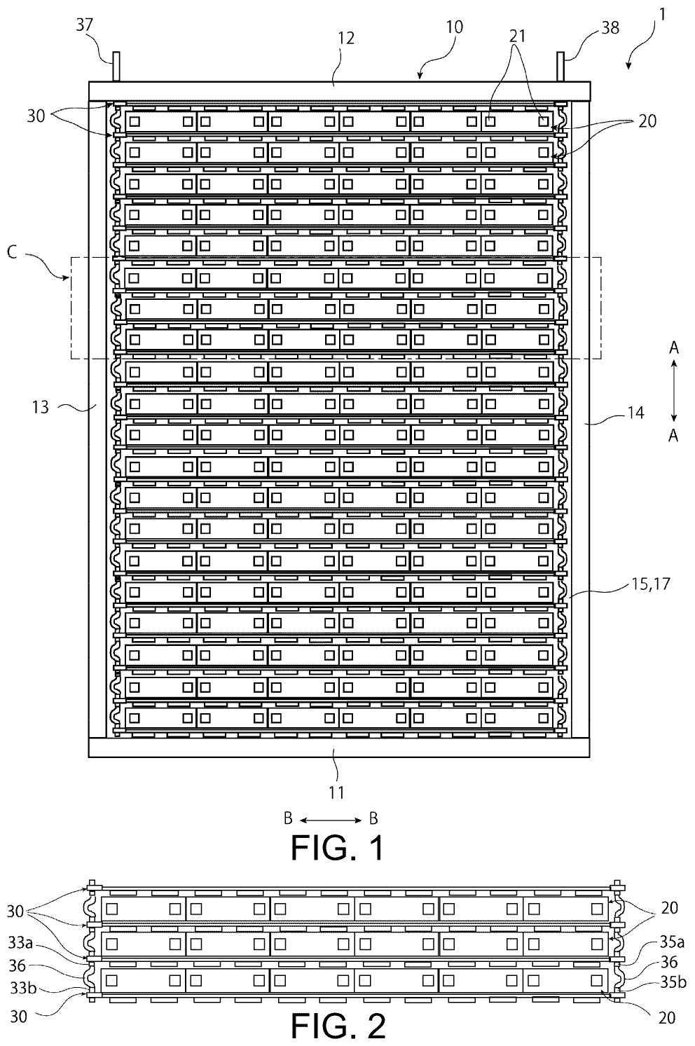

This embodiment is a form in which coolant inlet pipes and coolant outlet pipes of coolant jackets are connected by a flexible hose. As shown in FIG. 1 and an enlarged view of a part C of FIG. 1 in FIG. 2, a battery pack 1 of this embodiment includes a battery case 10, a plurality of battery cells 20, and a plurality of coolant jackets 30.

The battery case 10 has a thin box shape composed of a front end plate 11 and a rear end plate 12 provided at both end parts in a first direction (front-rear direction A-A), a left end plate 13 and a right end plate 14 provided at both end parts in a second direction (left-right direction B-B), a bottom plate 15, and an upper plate (not shown).

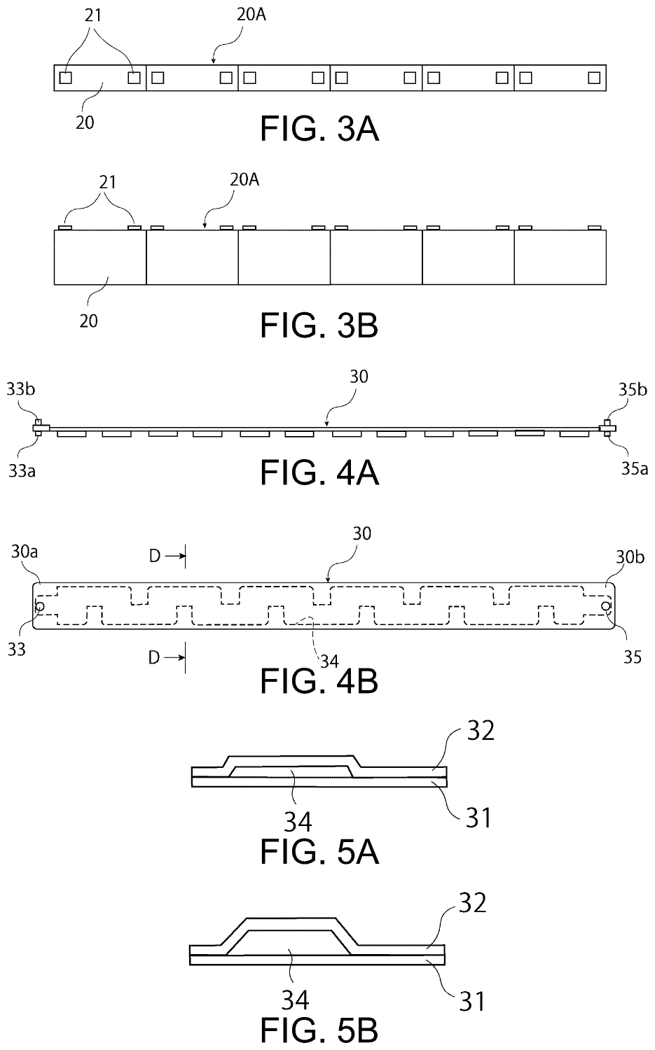

As shown in FIG. 3A and FIG. 3B, in this embodiment, the battery cell 20 is a rectangular lithium-ion battery, with two terminals 21 protruding on an upper side. The battery cells 20 form a cell joined body 20A with six battery cells 20 arranged and joined in a row in the second direction (left-right direction). However, the shape of the battery cell 20 in the disclosure is not limited to a rectangular shape and may also be, for example, a cylindrical shape. Nonetheless, there are advantages to adopting a rectangular shape, such as not requiring a resin to fill between the battery cells 20 and having less environmental impact during recycling. Further, the type of the battery is not limited to a lithium-ion battery and may also be an all-solid-state lithium-ion battery or a sodium-ion battery.

The coolant jacket 30 is a component that is alternately arranged in surface contact with the cell joined body 20A in the first direction (front-rear direction) in the battery case 10 and cools each battery cell 20. As shown in FIG. 4A and FIG. 4B, each coolant jacket 30 is a roll bonded component composed of two aluminum-made thin plates 31 and 32 (see FIG. 5A and FIG. 5B) having plasticity that are surface-joined to each other, and a coolant inlet 33, a coolant passage 34, and a coolant outlet 35 that are formed as gap portions between the two thin plates. By flowing a non-compressed fluid (water at 3.4 MPa in this embodiment) at a predetermined pressure into the coolant passage 34 of the coolant jacket 30 to push and expand the coolant passage 34, even a coolant (water at 0.3 MPa) at a normal pressure can flow therethrough. At the same time, since the coolant jacket 30 expands due to plastic deformation, the cell joined body 20A and the coolant jacket 30 are clamped and fixed between the front end plate 11 and the rear end plate 12 (see FIG. 1) forming both end plates of a battery cell accommodating part 17.

The coolant jacket 30 includes one end part 30a protruding from a one end side (left side) of the cell joined body 20A in the second direction (left-right direction), and an other end part 30b protruding from an other end side (right side) of the cell joined body 20A. The coolant inlet 33 includes a one surface side inlet pipe 33a protruding in the first direction (front-rear direction) from a one surface side (front side) of the one end part 30a, and an other surface side inlet pipe 33b protruding in the first direction (front-rear direction) from an other surface side (rear side) of the one end part 30a. On the other hand, the coolant outlet 35 includes a one surface side outlet pipe 35a protruding in the first direction (front-rear direction) from the one surface side (front side) of the other end part 30b, and an other surface side outlet pipe 35b protruding in the first direction (front-rear direction) from the other surface side (rear side) of the other end part 30b.

As shown in FIG. 2, of two coolant jackets 30 adjacent to each other with the cell joined body 20A interposed therebetween, the one surface side inlet pipe 33a of one of the coolant jackets 30 is connected to the other surface side inlet pipe 33b of the other of the coolant jackets 30 via an aluminum-made flexible hose 36. Further, the one surface side outlet pipe 35a of the one of the coolant jackets 30 is connected to the other surface side outlet pipe 35b of the other of the coolant jackets 30 via a flexible hose 36. In this manner, all the coolant inlets 33 of the coolant jackets 30 arranged in the battery case 10 are connected to each other, the coolant outlets 35 are connected to each other, a one surface side inlet pipe 33a and a one surface side outlet pipe 35a of the frontmost-stage coolant jacket 30 are not provided, and the one surface side is sealed. On the other hand, a coolant supply pipe 37 (see FIG. 1) is connected to the other surface side inlet pipe 33b of the last-stage coolant jacket 30, and a coolant return pipe 38 (see FIG. 1) is connected to the one surface side outlet pipe 35a. When a coolant (water) is supplied from the coolant supply pipe 37 to a group of coolant jackets 30 connected in this manner, this water branches and flows in parallel in the coolant passage 34 of each coolant jacket 30 to cool the battery cells 20, and merges and flows into the coolant return pipe 38.

The two terminals 21 (see FIG. 3A and FIG. 3B) protruding on the upper side of each battery cell 20 are connected to a bus bar (not shown), which is a conductive plate, by welding and are connected in parallel and in series in the battery pack to be eventually integrated into a positive side terminal (not shown) and a negative side terminal (not shown) of the entire battery pack. Each battery cell 20 may be charged by applying a voltage between the positive side terminal and the negative side terminal from outside, and the power charged in each battery cell 20 may also be supplied from the positive side terminal and the negative side terminal to an automobile drive motor and the like.

Next, a manufacturing method of the battery pack 1 of this embodiment configured in this manner will be described.

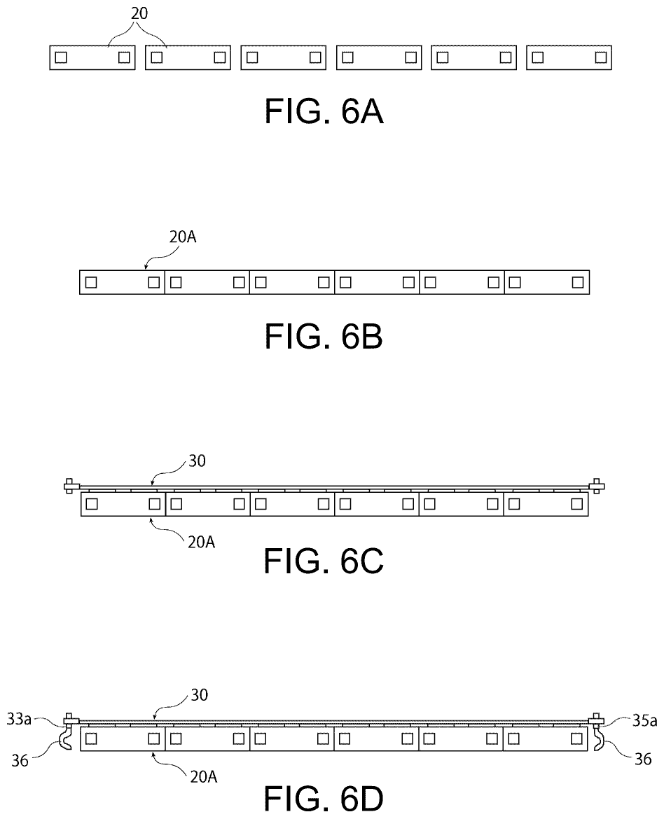

First, as shown in FIG. 6A and FIG. 6B, a plurality of battery cells 20 are joined, with multiple (six in this embodiment) battery cells 20 arranged in each row in the second direction (left-right direction), to form a cell joined body 20A (FIG. 6B).

Next, the cell joined body 20A and the coolant jacket 30 are alternately arranged in surface contact with each other in the first direction (front-rear direction) and are adhered to each other. Specifically, first, one coolant jacket 30 is adhered in surface contact with one cell joined body 20A (FIG. 6C), and aluminum-made flexible hoses 36 are attached respectively to the one surface side inlet pipe 33a and the one surface side outlet pipe 35a provided at the left and right end parts of the coolant jacket 30 (FIG. 6D).

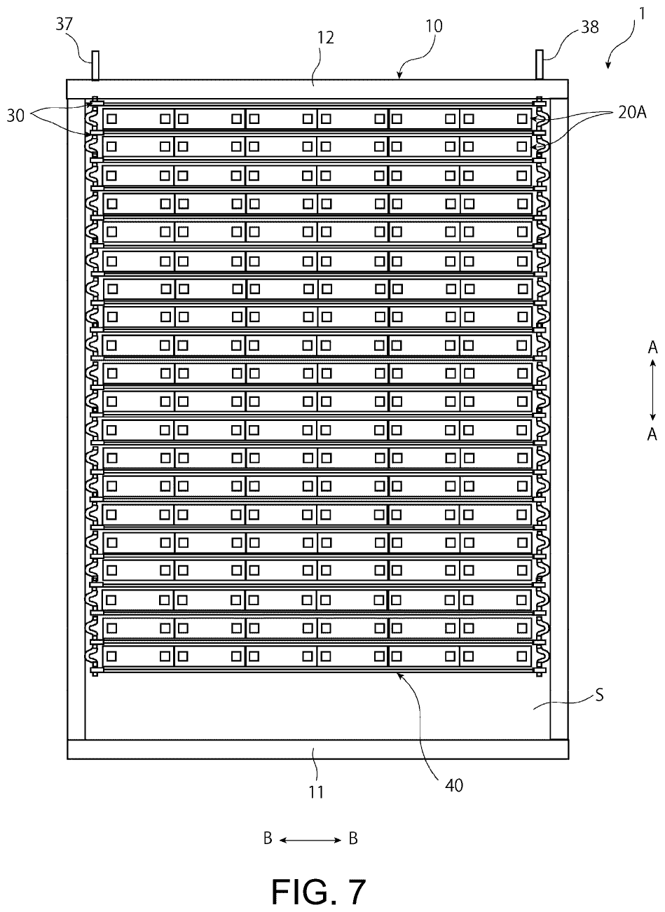

Next, as shown in FIG. 7, the adhered body of the cell joined body 20A and the coolant jacket 30 is arranged and adhered one after another in the battery case 10. By this adhesion, it is possible to prevent misalignment of the battery cells 20 in a process of expanding the coolant jackets 30 to be described later.

At this time, as shown in FIG. 2, of two coolant jackets 30 adjacent to each other with the cell joined body 20A interposed therebetween, the flexible hoses 36 respectively attached to the one surface side inlet pipe 33a and the one surface side outlet pipe 35a of one of the coolant jackets 30 are respectively fitted with the other surface side inlet pipe 33b and the other surface side outlet pipe 35b of the other of the coolant jackets 30, and thus the inlet pipes (33a and 33b) and the outlet pipes (35a and 35b) are respectively connected to each other. A one surface side inlet pipe 33a and a one surface side outlet pipe 35a of the frontmost-stage coolant jacket 30 are not provided, and the one surface side is sealed.

When all the adhered bodies of the cell joined bodies 20A and the coolant jackets 30 are arranged and adhered, all the coolant inlets 33 of the coolant jackets 30 arranged in the battery case 10 are connected to each other, and all the coolant outlets 35 are also connected to each other.

In a cell body 40 thus formed, which is a block in which the cell joined bodies 20A and the coolant jackets 30 alternately arranged as shown in FIG. 7, since a thickness of the coolant jacket 30 has not yet expanded, a dimension of the cell body 40 in the first direction (front-rear direction) is sufficiently smaller than a dimension of the battery cell accommodating part 17 in the battery case 10. Thus, in the first direction, a space S is present between the cell body 40 and the rear end plate 12 or the front end plate 11, and various transportation methods of the adhered bodies of the cell joined bodies 20A and the coolant jackets 30 may be adopted.

Next, upon sealing the one surface side outlet pipe 35a of the last-stage coolant jacket 30, a coolant supply pipe 37 is connected to the other surface side inlet pipe 33b, and a non-compressed fluid (water at 3.4 MPa in this embodiment) at a predetermined pressure is flowed into the coolant passage 34 (see FIG. 4B) of the coolant jacket 30. This non-compressed fluid may be the same as or different from the coolant. Accordingly, since the coolant jacket 30 expands due to plastic deformation, even if the coolant pressure is set to zero, the deformation state is maintained, and even a coolant (water at 0.3 MPa) at a normal pressure can flow through the expanded coolant passage 34. At the same time, since the pressure on the battery cells 20 is also maintained, the cell joined bodies 20A and the coolant jackets 30 are clamped and fixed between the rear end plate 12 and the front end plate 11 forming both end plates of the battery cell accommodating part 17, and positions of the terminals 21 of the battery cells 20 are correctly positioned (FIG. 1).

A bus bar (not shown), which is a conductive plate, is placed on a surface (upper surface in FIG. 1) on which the terminals 21 of each battery cell 20 are arranged, and is welded to each terminal 21.

Furthermore, by connecting the coolant supply pipe 37, the coolant return pipe 38, etc., filling a urethane foam into gaps around the cell body 40, and adhering an upper plate (not shown), a battery pack 1 is completed.

According to this embodiment, after arranging the battery cells 20 and the coolant jackets 30 before expansion alternately with gaps being present with respect to the two opposing end plates (11 and 12), by expanding the coolant jackets 30, the battery cells 20 can be fixed in a state in which a pressure is applied to the battery cells 20.

Further, since the coolant jacket 30 expands due to plastic deformation, even if a hydraulic pressure is set to zero, the deformation state is maintained, and the pressure on the battery cell 20 is also maintained. Thus, another pressing mechanism is not required and the structure can be simplified.

### Second Embodiment

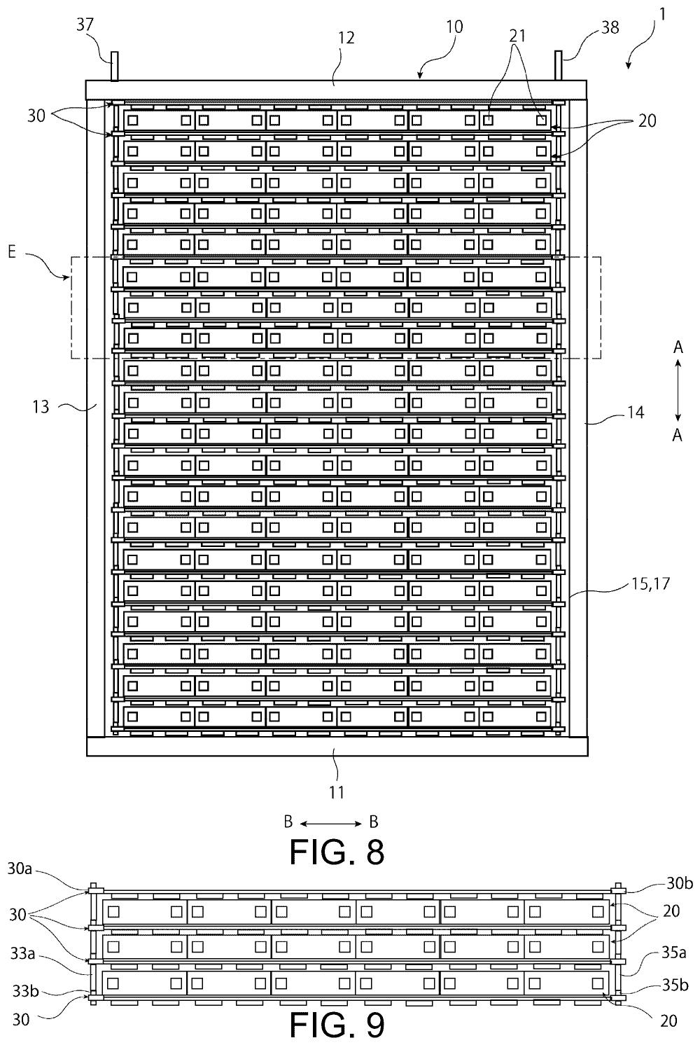

This embodiment is a form in which straight steel pipes (33a, 33b, 35a, and 35b) are connected to each other without using the flexible hose 36 as a pipe connecting between the coolant jackets 30 in the first embodiment. The same or substantially the same components as those in the first embodiment will be labeled with the same reference signs, and repeated descriptions thereof will be omitted. FIG. 8 shows a plan view of a battery pack according to this embodiment, and FIG. 9 shows an enlarged view of a part E.

The coolant jacket 30 includes one end part 30a protruding from a one end side (left side) of a cell joined body 20A in the second direction (left-right direction), and an other end part 30b protruding from an other end side (right side) of the cell joined body 20A. The coolant inlet 33 includes a one surface side inlet pipe 33a protruding in the first direction (front direction) from one surface side (front side) of the one end part 30a, and an other surface side inlet pipe 33b protruding in the first direction (rear direction) from an other surface side (rear side) of the one end part 30a. An outer circumference of the other surface side inlet pipe 33b is formed into a dimension press-fitted into an inner circumference of the one surface side inlet pipe 33a.

On the other hand, the coolant outlet 35 includes a one surface side outlet pipe 35a protruding in the first direction (front direction) from the one surface side (front side) of the other end part 30b, and an other surface side outlet pipe 35b protruding in the first direction (rear direction) from the other surface side (rear side) of the other end part 30b. An outer circumference of the other surface side outlet pipe 35b is also formed into a dimension press-fitted into an inner circumference of the one surface side outlet pipe 35a.

When two coolant jackets 30 are pressure-welded with the cell joined body 20A interposed therebetween, the other surface side inlet pipe 33b of one of the coolant jackets 30 is press-fitted and connected into the one surface side inlet pipe 33a of the other of the coolant jackets 30. Further, the other surface side outlet pipe 35b of one of the coolant jackets 30 is press-fitted and connected into the one surface side outlet pipe 35a of the other of the coolant jackets 30. In this manner, all the coolant inlets 33 of the coolant jackets 30 arranged in the battery case 10 are connected to each other, the coolant outlets 35 are connected to each other, a one surface side inlet pipe 33a and a one surface side outlet pipe 35a of the frontmost-stage coolant jacket 30 are not provided, and the one surface side is sealed. On the other hand, a coolant supply pipe 37 is connected to the other surface side inlet pipe 33b of the last-stage coolant jacket 30, and a coolant return pipe 38 is connected to the one surface side outlet pipe 35a.

With respect to a group of coolant jackets 30 connected in this manner, the coolant supply pipe 37 is connected to the other surface side inlet pipe 33b, and a non-compressed fluid (water at 3.4 MPa in this embodiment) at a predetermined pressure is flowed into the coolant passages 34 (see FIG. 4B) of the coolant jackets 30. Accordingly, similar to the first embodiment, the coolant jacket 30 expands due to plastic deformation, and even a coolant (water at 0.3 MPa) at a normal pressure can flow through the expanded coolant passage 34. At the same time, the cell joined bodies 20A and the coolant jackets 30 are clamped and fixed between the rear end plate 12 and the front end plate 11 forming both end plates of the battery cell accommodating part 17, and positions of the terminals 21 of the battery cells 20 are correctly positioned (FIG. 1).

At this time, due to the expansion of each coolant jacket 30, a tension is applied to a fitting portion between the one surface side inlet pipe 33a and the other surface side inlet pipe 33b and a fitting portion between the one surface side outlet pipe 35a and the other surface side outlet pipe 35b described above. However, since the thicknesses of the one end part 30a and the other end part 30b of the coolant jacket 30 also expand, the fitting is maintained.

Other configurations are the same as the first embodiment, and the manufacturing method is also the same as the first embodiment except that the flexible hose 36 is not used in the assembly process. Since it is not required to attach the flexible hose 36 (see FIG. 2) to the one surface side inlet pipe 33a and the one surface side outlet pipe 35a in the assembly process, the assembly process can be simplified.

Although the embodiments of the disclosure have been described above, the disclosure is not limited to these embodiments, and various modifications may be made within the scope of the patent claims and the technical concepts described in the specification and drawings.

For example, each of the above embodiments describes an example of applying to a battery pack 1 in a cell-to-pack form that directly accommodates battery cells 20 in a battery case 10 without modularizing the battery cells 20. However, the disclosure is not limited thereto and may also be applied to a battery pack 1 in a module-to-pack form. In that case, within a frame of a module, by arranging the battery cells 20 and the coolant jackets 30 alternately in surface contact with each other in the first direction and flowing a non-compressed fluid at a predetermined pressure into the coolant passage 34 of each coolant jacket 30 to expand the coolant jacket 30 by plastic deformation, a plurality of battery cells 20 and a plurality of coolant jackets 30 are clamped and fixed between two end plates opposed in the first direction to thus form a module, and a plurality of such modules may be arranged in a battery pack 1.

Further, the pipe connection structure on the inlet side and the outlet side of the coolant jacket 30 is not limited to those of the above embodiments, and may be any structure that allows a coolant to circulate in the coolant jackets 30.

What is claimed is:

1. A battery pack comprising:
a battery case in a substantially box shape;
a plurality of battery cells accommodated in the battery case; and
a plurality of coolant jackets cooling the plurality of battery cells, wherein
each of the coolant jackets comprises two thin plates having plasticity that are surface-joined to each other, and a coolant inlet, a coolant passage, and a coolant outlet that are formed as gap portions between the two thin plates,
the battery cell and the coolant jacket are alternately in surface contact with each other and arranged in a first direction in the battery case, and
by flowing a non-compressed fluid at a predetermined pressure into the coolant passage of each of the coolant jackets to expand the coolant jacket by plastic deformation, the plurality of battery cells and the plurality of coolant jackets are clamped and fixed between two end plates opposed in the first direction.

2. The battery pack according to claim 1, wherein the two end plates are ends plates constituting both end parts of a battery cell accommodating part in the battery case.

3. The battery pack according to claim 2, wherein the plurality of battery cells constitute cell joined bodies each with multiple battery cells arranged and joined in a row in a second direction orthogonal to the first direction, and
the cell joined body and the coolant jacket are alternately arranged in surface contact with each other in the first direction in the battery case.

4. The battery pack according to claim 3, wherein the coolant jacket comprises a one end part protruding from a one end side of the cell joined body in the second direction, and an other end part protruding from an other end side of the cell joined body,
the coolant inlet comprises a one surface side inlet pipe protruding in the first direction from a one surface side of the one end part, and an other surface side inlet pipe protruding in the first direction from an other surface side of the one end part,
the coolant outlet comprises a one surface side outlet pipe protruding in the first direction from the one surface side of the other end part, and an other surface side outlet pipe protruding in the first direction from the other surface side of the other end part,
upon bringing two of the coolant jackets adjacent to each other with the cell joined body interposed therebetween, the one surface side inlet pipe of one of the coolant jackets is connected to the other surface side inlet pipe of the other of the coolant jackets, and
the one surface side outlet pipe of the one of the coolant jackets is connected to the other surface side outlet pipe of the other of the coolant jackets.

5. The battery pack according to claim 4, wherein a connection between the one surface side inlet pipe and the other surface side inlet pipe and a connection between the one surface side outlet pipe and the other surface side outlet pipe are each performed via a flexible hose.

6. The battery pack according to claim 4, wherein the predetermined pressure is ten times or more a pressure of a coolant of normal use.

7. The battery pack according to claim 6, wherein the predetermined pressure is 3±0.5 MPa.

8. The battery pack according to claim 3, wherein the battery cell or the cell joined body is fixed to an adjacent coolant jacket by adhesion.

9. A manufacturing method of a battery pack, which is a method of manufacturing a battery pack comprising:
a battery case in a substantially box shape;
a plurality of battery cells accommodated in the battery case; and
a plurality of coolant jackets cooling the plurality of battery cells, wherein
each of the coolant jackets comprises two thin plates having plasticity that are surface-joined to each other, and a coolant inlet, a coolant passage, and a coolant outlet that are formed as gap portions between the two thin plates,
the manufacturing method comprising:
bringing the battery cell and the coolant jacket into surface contact alternately with each other in the battery case to arrange in a first direction in the battery case; and
flowing a non-compressed fluid at a predetermined pressure into the coolant passage of each of the coolant jackets to expand the coolant jacket by plastic deformation, thereby clamping and fixing the plurality of battery cells and the plurality of coolant jackets between two end plates opposed in the first direction.
